(19) United States
(12) Patent Application Publication
(10) Pub. No.: US 2002/0128854 A1
(43) Pub. Date: Sep. 12, 2002

(54) Recipe audit system

(76) Inventor: Golden Wu, A-lien Hsiang (TW)

Correspondence Address: J.C. Patents, Inc., Suite 250, 4 Venture, Irvine, CA, 92618, US

(21) Appl. No.: 09/950,218

(22) Filed: Sep. 7, 2001

(30) Foreign Application Priority Data
Mar. 7, 2001 (TW) 90105275

(51) Int. Cl. G06F 17/60

(52) U.S. Cl. 705/1

(57) ABSTRACT

A method of automatically auditing recipe for figuring out whether manufacturing machines can perform manufacturing processes, wherein each of the manufacturing machines is respectively coupled with a computer. A recipe is accessed from the manufacturing machine. The recipe is recognized. The recognized recipe is checked with a standard data in the database. The manufacturing machine is informed to perform a manufacturing process according to the recipe when a checking result of the checking step is normal.

### CROSS-REFERENCE TO RELATED APPLICATION

This application claims the priority benefit of Taiwan application serial no. 90105275, filed Mar. 7, 2001.

### BACKGROUND OF THE INVENTION

1. Field of Invention

The present invention relates to an over-platform recipe audit system and a method for auditing over-platform recipe. More particularly, the present invention relates to an on-line recipe audit system and the method thereof when the recipe changes.

2. Description of Related Art

In the current manufacturing technology, some manufacturers only can provide the particular audit functions for their own machines. However, these particular audit functions or system cannot be used to audit other machine produced by different manufacturers. Therefore, it is hard to improve the product manufacturing quality.

### SUMMARY OF THE INVENTION

The present invention provides an automatically auditing recipe system. Even if the process system is performed in different machines, the system is capable for the recipe-checking function built in over-platform machine. The system includes a control computer and a recipe-controlling server.

The control computer is connected with computers of the machines. The recipe-controlling server is connected with the control computer in order to recognize and check the recipes accessed from the computers of the machines.

Moreover, the system also comprises a database connected with the recipe-controlling server. The database is used to save standard data. The standard data are used as a checking basis during the recipes are checked by the recipe-controlling server.

The system further comprises a user's computer connected with the recipe-controlling server. The user can command the user computer to perform a programmed recipe checking process in any time even during the manufacturing machines are busy in performing the manufacturing process. The programmed recipe checking process is allowed to select one of the manufacturing machines and a particular process.

The invention provides a recipe automatic audit method for judging whether manufacturing machines can perform manufacturing processes. Each of the manufacturing machines is respectively coupled with a corresponding field computer. A recipe is extracted from one of the manufacturing machine. The recipe is recognized. The recognized recipe is checked with standard data in the database. The manufacturing machine is informed to perform a manufacturing process according to the recipe when a checking result is normal.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of a recipe audit system according to a preferred embodiment of this invention; and

FIG. 2 is a flow chart of a method for automatically auditing recipe in accordance with a preferred embodiment of this invention.

### DESCRIPTION OF THE PREFERRED EMBODIMENTS

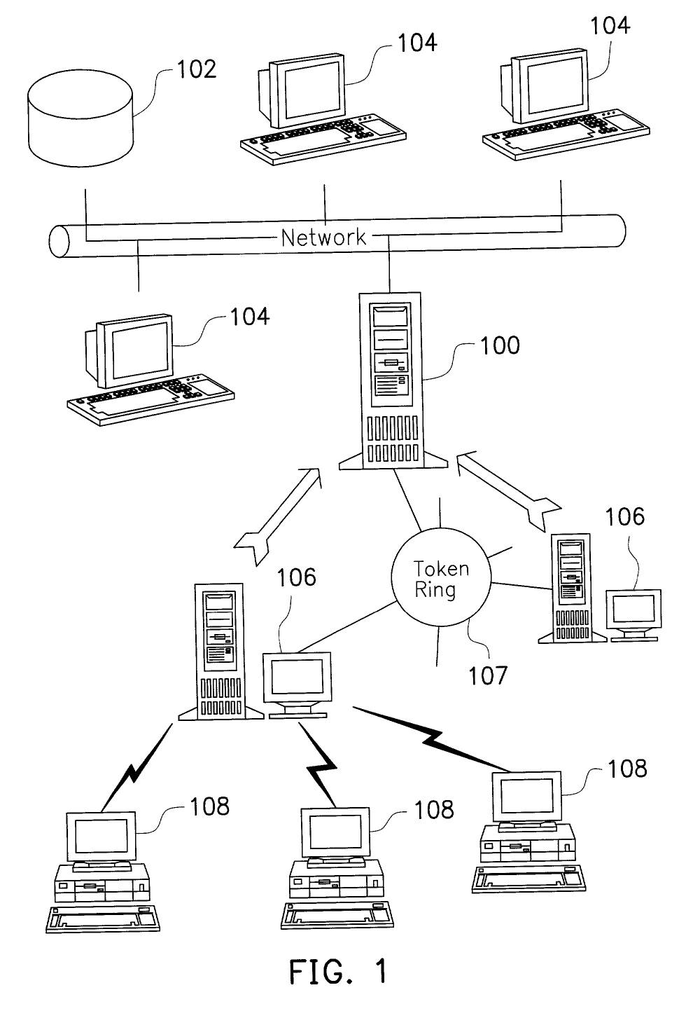

FIG. 1 is a schematic of a recipe audit system according to a preferred embodiment of this invention. The recipe audit system is a system used to figure out whether manufacturing machines can perform the manufacturing processes in which each of the manufacturing machine has a corresponding computer.

The recipe audit system comprises a control computer 106 and a recipe-controlling server 100. The control computer 106 is connected with a computer 108 built in each manufacturing machine. It should be noticed that the control computer 106 is not limited to be in contact with only one computer 108.

As shown in FIG. 1, the control computer 106 can be in contact with several computers 108 to access recipes from the computers 108 at the same time. The recipe-controlling server 100 is in contact with the automatic control computer 106 to recognize and check the recipes accessed from the computers 108.

Moreover, the recipe audit system comprises a data base 102 connected with the recipe-controlling server 100. The database 102 is used to save standard data and the standard data are used as a checking basis during the performance of the recipe checking process by the recipe-controlling server 100. If the checking result is normal, the manufacturing machine corresponding to the machine-on-computer is assigned to perform the predetermined manufacturing processes. Otherwise, the manufacturing machine with abnormal checking result in shutdown and the checking list is printed to show what the problems are.

Besides the database 102, the recipe audit system further comprises a user computer 104. The user computer 104 is connected with the recipe controlling server 100 and a recipe checking means is installed into the user computer 104. The recipe checking process is performed before the manufacturing process is performed and sometimes, the controlling program of the manufacturing machine should also be checked, so that the manually imported automatic recipe checking schedule can make the operation of the checking process more flexible.

Therefore, the users can operate the control program to perform the checking process by using the user computer 104 at any time, even when the manufacturing machines are busy in performing manufacturing process, allowing the users to select a particular manufacturing machine and to select a particular program for performing checking processes as and when required.

Moreover, since the operation systems, and the central system of each manufacturing machine are produced by different manufacturers, accordingly, the recipe recognizing processes performed by the recipe controlling server 100 would be different. Therefore, the recipes transferred from every computer that are used to control the manufacturing machine are different from each other. Likewise, the operation system in the automatic control computer 106 is also different from the operation system in the computer 108 for controlling a machine. In order to solve the incompatibility problems described above, a transferring controlling protocol such as SECSII communication protocol is used between the automatic control computer 106 and the computers 108 and a token ring network is used for communication between the recipe controlling server 100 and automatic control computer 106. The transferring controlling protocol and the communication network together will enable the recipe recognizing process and then the recognized recipes are checked by the recipe controlling server 100.

Furthermore, the recipe-controlling server 100 comprises a detection means by which the status of the machines can be checked at any given time. Hence, this would provide a good process control. For example, the detection means will allow a user to program the recipe-controlling server 100 to automatically perform the recipe checking process when the process machine is not in operation. Additional advantage is that the user need not physically be present at the processing facility to check whether or not a process machine is operational during operation and inspection schedule.

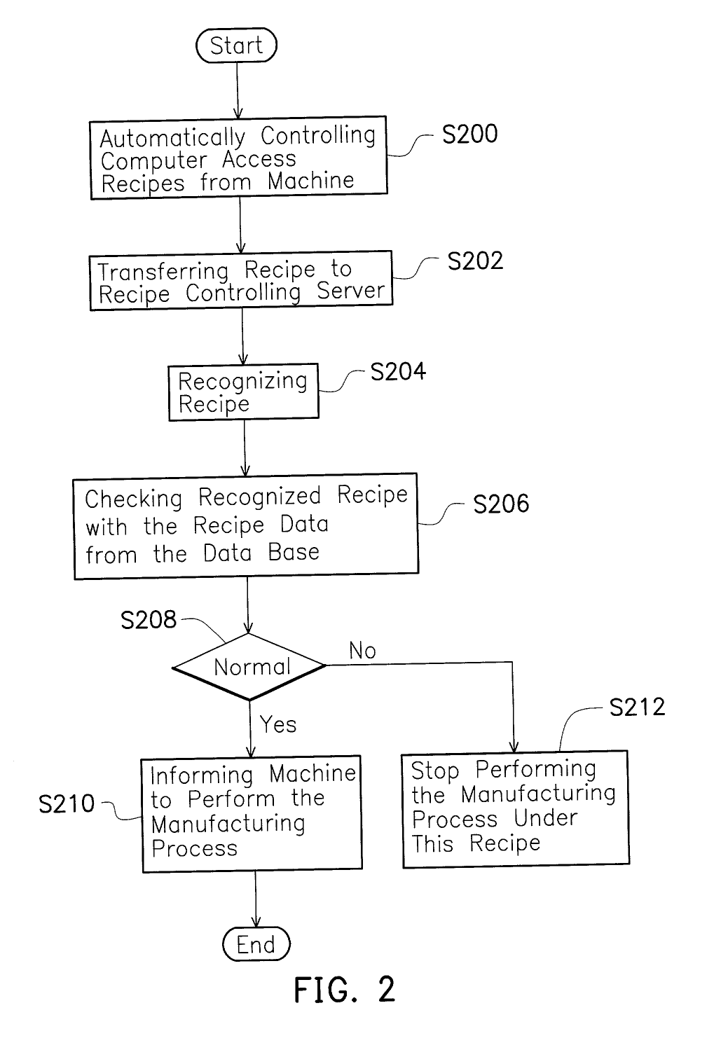

FIG. 2 is a schematic of a method of automatically auditing recipe according to one preferred embodiment of this invention. The method of auditing recipe is used to figure out whether manufacturing machine can perform the manufacturing processes. Each manufacturing machine has a corresponding particular computer.

As shown in FIG. 2, at step S200, the recipes are accessed from the manufacturing machine. At step S202, the recipes are transferred to the recipe-controlling server 100. At step S204, the recipe-controlling server starts to recognize the recipes. As shown in step S206, based on the standard data in the database, the recognized data are checked by the recipe-controlling server 100. When the checking result is normal, as shown in step S208, the recipe controlling server 100 informs the manufacturing machine to continue the manufacturing processes, as shown in step S210. On the contrary, when checking result is abnormal, the recipe-controlling server 100 informs the manufacturing machine to stop performing the manufacturing processes.,

In the present invention, not only is the recipe checking process performed before the manufacturing processes are performed, but also the users can manually import the automatic recipe checking schedule at will. Furthermore, the users can perform program checking process in any time even during the manufacturing machine is busy in performing manufacturing processes. Incidentally, the users are allowed to select a particular manufacturing machine and to select a particular program for performing checking processes at will during the checking processes.

After the manufacturing processes are performed, the detailed check list can be printed. The detailed check list shows the list of names of the manufacturing machines, the process names, the checking time and the checking result. The detailed check list also shows the abnormal recipes.

The present invention possesses the following advantages:

1. In the present invention, the recipe checking is performed before the manufacturing process is performed and the users are on-line warned by the recipe audit system when the present recipes are abnormal so that the product quality can be well controlled.

2. The automatic recipe checking is performed during the manufacturing machine available time. Therefore, the manufacturing processes won't be affected by the automatic recipe checking.

3. Under the manual operation mode, the users can monitor the latest recipe-checking situation to avoid the abnormal recipe happening during the manufacturing processes.

4. The users can trace the problem leading the abnormal recipes and edit daily recipe history by viewing the checking list or table.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A recipe audit system for at least one manufacturing machine, the manufacturing machine being coupled with a corresponding field computer, the system comprising:
an automatizing control computer coupled with the field computer so as to extract a plurality of recipes from the filed computers; and
a recipe-controlling server coupled with the automatizing control computer so as to recognize and to check the recipes extracted from the automatizing control computer.

2. The recipe audit system of claim 1, further comprising:
a database coupled with the recipe-controlling server.

3. The recipe audit system of claim 2, wherein the data base contain a standard data serving as a checking basis of the process of checking recipe.

4. The recipe audit system of claim 1, further comprising:
a user computer coupled with the recipe-controlling server, in which a recipe checking means in installed.

5. The recipe audit system of claim 4, wherein the recipe checking means can be commanded to perform a recipe checking process in any time even during the manufacturing machines are busy in performing manufacturing process.

6. The recipe audit system of claim 5, wherein during the recipe checking process, a particular manufacturing machine and a particular process are selected.

7. The recipe audit system of claim 1, wherein the recognization of the extracted recipe is varied with different machine.

8. The recipe audit system of claim 7, wherein the automatizing control computer and the field computers is communicated under a transfer control protocol.

9. The recipe audit system of claim 1, wherein the recipe controlling server comprises a detection means for checking the status of a process machine.

10. A recipe automatic audit method for at least one of the manufacturing machine being coupled with a corresponding field computer, the method comprising:
extracting a recipe from the at least one of the manufacturing machine;
recognizing the recipe;
checking the recognized recipe with standard data in a data base; and
informing the manufacturing machine to perform a manufacturing process according to the recognized recipe when the result of the checking step is normal.

11. The method of claim 10, wherein the step of extracting the recipe further comprises a step of transferring the extracted recipe to a recipe controlling server in which the extracted recipe will be recognized.

12. The method of claim 10, wherein when the result of the checking step is abnormal, the manufacturing machine is informed to stop performing the extracted recipe.

13. The method of claim 10, wherein the checking step comprises a step of setting an automatic recipe checking process.

14. The method of claim 13, wherein the checking step can be performed in any time even during the manufacturing machine is busy in performing the manufacturing process.

15. The method of claim 14, wherein during the recipe checking process a particular manufacturing machine and a particular process are selected.

16. The method of claim 10, further comprising a step of printing the result in the checking step.
